(19) United States
(12) Patent Application Publication
(10) Pub. No.: US 2008/0172800 A1
(43) Pub. Date: Jul. 24, 2008

(54) PLUG INSTALLATION TOOL

(76) Inventor: Moses Levy, Laval (CA)

Correspondence Address: GOUDREAU GAGE DUBUC, 2000 MCGILL COLLEGE, SUITE 2200, MONTREAL, QC, H3A 3H3, omitted

(21) Appl. No.: 11/972,922

(22) Filed: Jan. 11, 2008

Related U.S. Application Data
(60) Provisional application No. 60/885,685, filed on Jan. 19, 2007.

(51) Int. Cl. B25B 25/00; H01R 43/00

(52) U.S. Cl. 7/107; 29/760; 81/487

(57) ABSTRACT

An installation tool for manipulating a connector comprising a latch. The installation tool further comprises a shaft, a handle attached to an end of said shaft and an installation tip attached to an opposite end of said shaft and fashioned from a single piece of material, said tip comprising a pair of opposed resilient gripping members defining a connector receiving region there between and a latch depressing portion positioned at an extreme end of said tip, said connector receiving region dimensioned to snugly receive the connector there between. When the connector is inserted between said gripping members, said gripping members grip the connector while said latch depressing portion simultaneously depresses the latch.

### CROSS REFERENCE TO RELATED APPLICATIONS

This application claims priority on U.S. provisional application No. 60/885,685, filed on Jan. 19, 2007 which is incorporated herein in its entirety by reference.

### FIELD OF THE INVENTION

The present invention relates to an installation tool. In particular the present invention relates to a tool for installing and removing connector plugs and the like from their sockets, typically in patch panels or the like.

### BACKGROUND TO THE INVENTION

Increased interconnectivity means that the amount of computing and networking equipment being terminated in telecommunications cupboards or at patch bays also increases. This leads to a corresponding increase in the number of interconnections between sockets in patch bays which are used to interconnect the various pieces of computing and networking equipment. As telecommunications cupboards are typically of limited size, rack space is at a premium. One approach, therefore, to increasing the number of sockets without increasing the requisite amount of rack space is to increase the density of the sockets on a given patch panel. One drawback of this approach as that increased density means the separation between adjacent connectors inserted in the patch bays is small and therefore they are difficult to access, partly because the large number of cables which are incident on the patch panel face obscure the installers view and partly because the small separation means the mechanisms which must be actuated in order to release the cable plugs/connectors from their respective sockets are difficult to reach and actuate by the installer.

The prior art discloses a number of tools for installing and extracting the plugs/connectors terminating cables from their respective sockets. These prior art devices, however, have the drawback that they are based on the principle of pliers, have a number of moving parts and are relatively complex mechanically.

### SUMMARY OF THE INVENTION

In order to address the above and other drawbacks there is provided an installation tool for manipulating a connector comprising a latch, the tool comprising a shaft, a handle attached to an end of the shaft and an installation tip attached to an opposite end of the shaft and fashioned from a single piece of material, the tip comprising a pair of opposed resilient gripping members defining a connector receiving region there between and a latch depressing portion positioned at an extreme end of the tip, the connector receiving region dimensioned to snugly receive the connector there between. When the connector is inserted between the gripping members, the gripping members grip the connector while the latch depressing portion simultaneously depresses the latch.

There is also disclosed An installation tip for attachment an end of a shaft of an installation tool for manipulating a connector comprising a latch, the tool further comprising a handle attached to an opposite end of the shaft. The tip comprises a pair of opposed resilient gripping members defining a connector receiving region there between and a latch depressing portion positioned at an extreme end of the tip, said connector receiving region dimensioned to snugly receive the connector there between. The tool is fashioned from a single piece of material.

### BRIEF DESCRIPTION OF THE DRAWINGS

FIG. 1 is a perspective view of an installation tool in accordance with an illustrative embodiment of the present invention;

FIG. 2 is a detailed perspective view of the installation tool of FIG. 1 being used to remove a connector from a socket in a patch bay panel;

FIG. 3, is a plan view of the installation tool of FIG. 1 being used to install a connector in a patch bay panel;

FIG. 4 is a detailed perspective view of the installation tool of FIG. 1 being used to install a connector in a patch bay panel;

FIG. 5 is a perspective view of an installation tool in accordance with an alternative illustrative embodiment of the present invention;

FIGS. 6A through 6D provide perspective views of a variety of connectors and sockets;

FIG. 7 is a perspective view of an installation tool in accordance with a second alternative illustrative embodiment of the present invention; and

FIG. 8 is a perspective view of an installation tool in accordance with a third alternative illustrative embodiment of the present invention.

### DETAILED DESCRIPTION OF THE ILLUSTRATIVE EMBODIMENTS

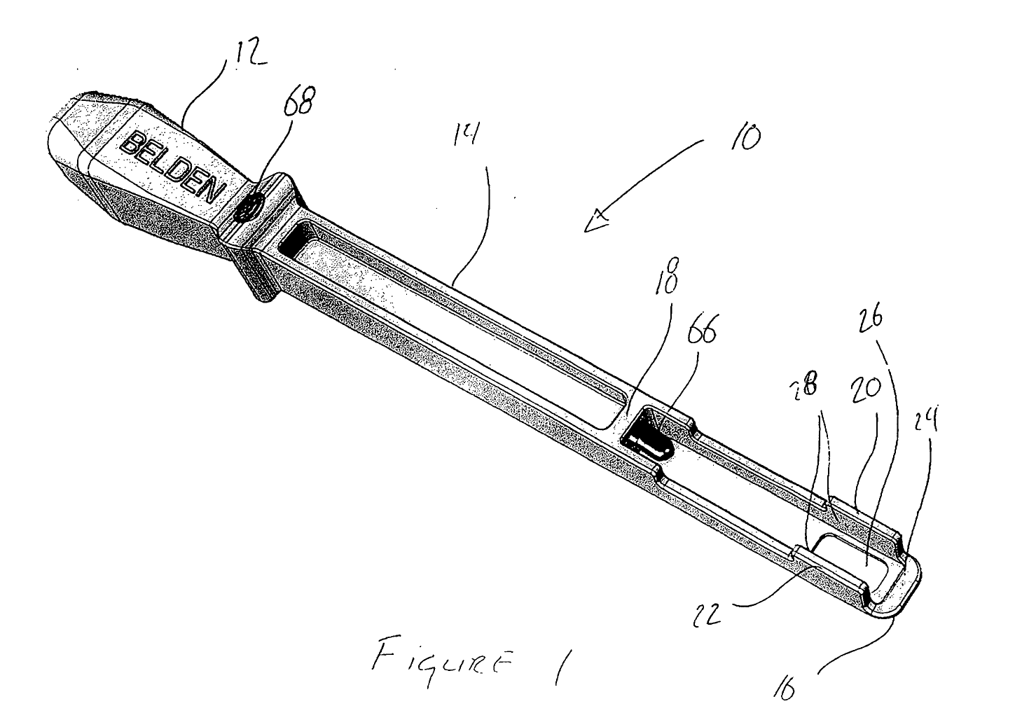

Referring now to FIG. 1, an installation tool, generally referred to using the reference numeral 10, will now be described. The tool 10 comprises a handle 12 attached to a shaft 14 which is terminated by a connector gripping tip 16 and is typically fabricated from a light resilient material such as plastic or the like. The shaft can include one or more stabilising cross members 18 to improve rigidity. Illustratively the spacing between the handle 12, shaft 14 and tip 16 remain in a predetermined spatial relationship but in a particular illustrative embodiment the shaft can telescope, thereby allowing the distance between the handle 12 and the tip 16 to be adjusted.

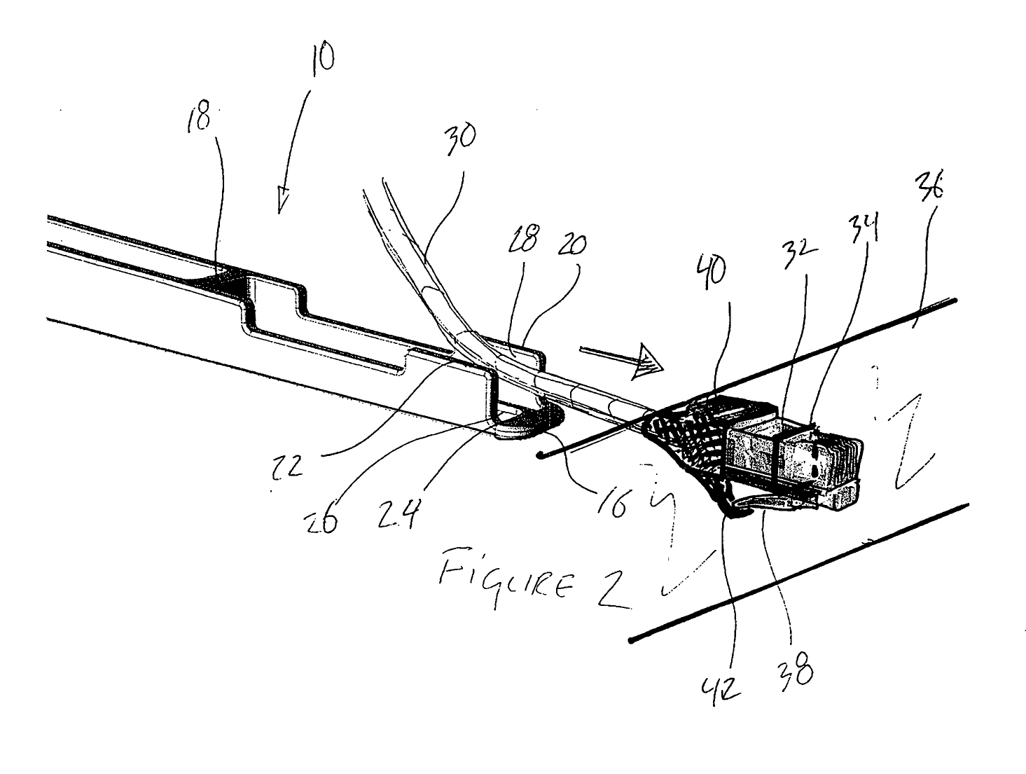

Referring to FIG. 2 in addition to FIG. 1, the connector gripping tip 16 is comprised of a pair of opposed gripping members 20, 22, illustratively rectangular and flat interconnected by a latch depressing portion 24. The latch depressing portion 24 optionally includes a slot 26 machined or otherwise moulded therein. In a particular embodiment the inner gripping surfaces as in 28 of the pair of opposed gripping members 20, 22 can be provided with a friction increasing material (not shown) such as soft rubber or the like.

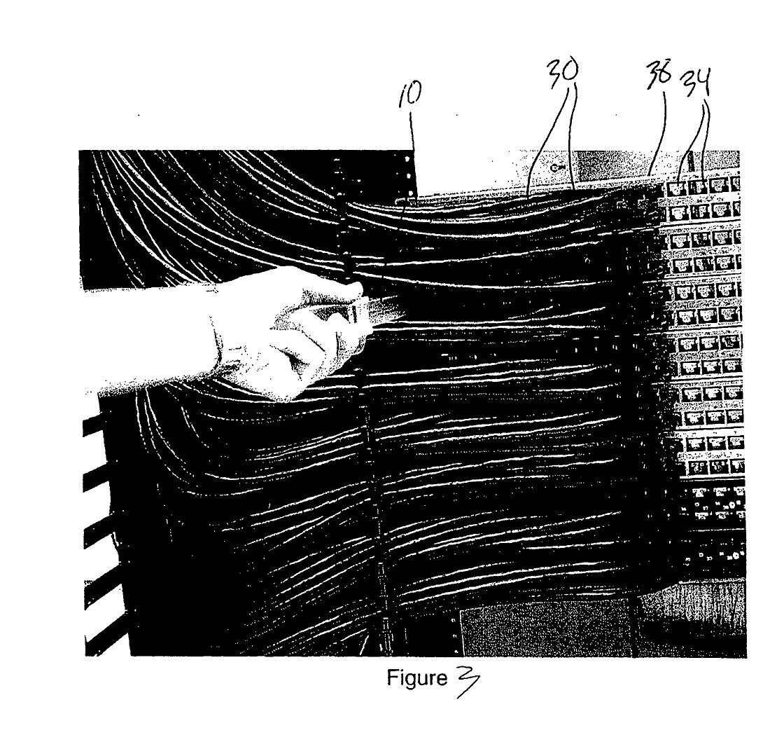

Referring now to FIG. 3, cables as in 30 are typically terminated by a connector 32 which is inserted into a socket 34, for example one of a plurality of like sockets 34 in patch bay panel 36, and held in the socket 34 through the interaction of a latch 38 with the socket 34.

Referring back to FIG. 2, as known in the art, in order to remove the connector 32 from the socket 34, the latch 38 must be actuated. In using the tool 10 to remove a connector 32 or the like from a socket 34, the gripping tip 16 is pushed onto the connector 32 such that the opposed gripping members 20, 22 grip the connector 32 there between while the latch depressing portion 24 simultaneously actuates the latch 38 there by releasing the connector 32 from the socket 34. In this regard, the opposed gripping members 20, 22 are resilient and integral with the rest of the tool 10 but are able to flex slightly relative to one another. The connector 32, which fits snugly between the opposed gripping members 20, 22 forces the opposed gripping members 20, 22 slightly outward thereby bringing a gripping force to bear on the connector 32. In a particular embodiment the opposed flanges could be equipped with a mechanism including an adjusting screw or the like (not shown) in order to adjust the width of the gap defined between the opposed gripping members 20, 22 thereby allowing for variations in the width of the connector 32 (for example in the event the connector is equipped with a boot 40 or the like). In the event that the connector 32 is equipped with an anti-snag feature 42, during plug extraction the anti-snag feature 42 fits into the optional slot 26, thereby allowing the latch 38 to be freely actuated.

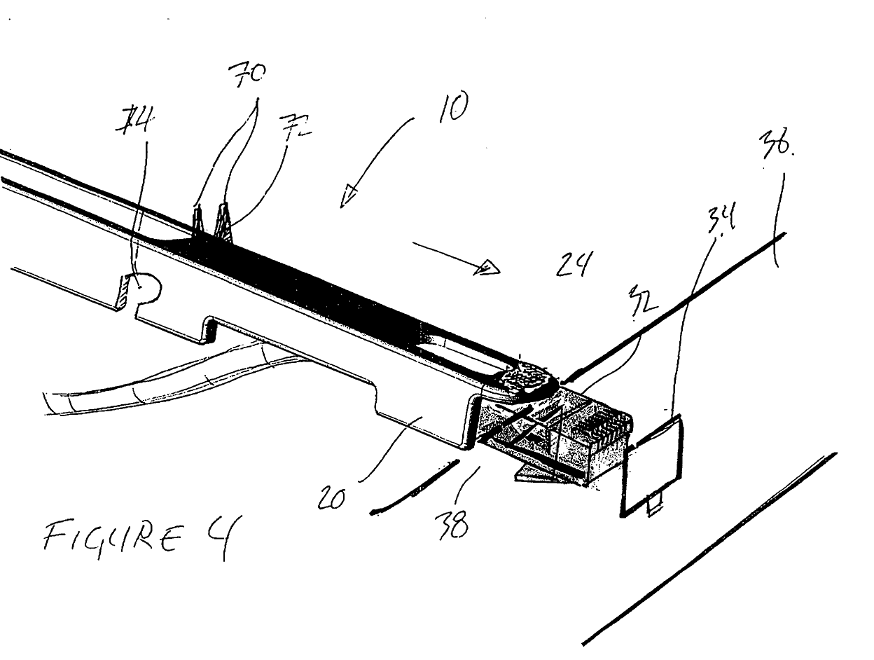

Referring now to FIG. 4, in order to install a connector 32 into the socket 34, the tool 10 is flipped and the connector 32 gripped between the opposed gripping members 20, 22 such that the latch 38 points away from the latch depressing portion 24. The connector 32 can then be conveniently inserted in the socket 34 in the patch bay panel 36 or the like wherein the latch 38 will be engaged thereby locking the connector 32 in the socket 34. Once the connector 32 has been locked into the socket 34 the tool 10 can be easily retracted, the opposed gripping members 20, 22 releasing their grip on the connector 32.

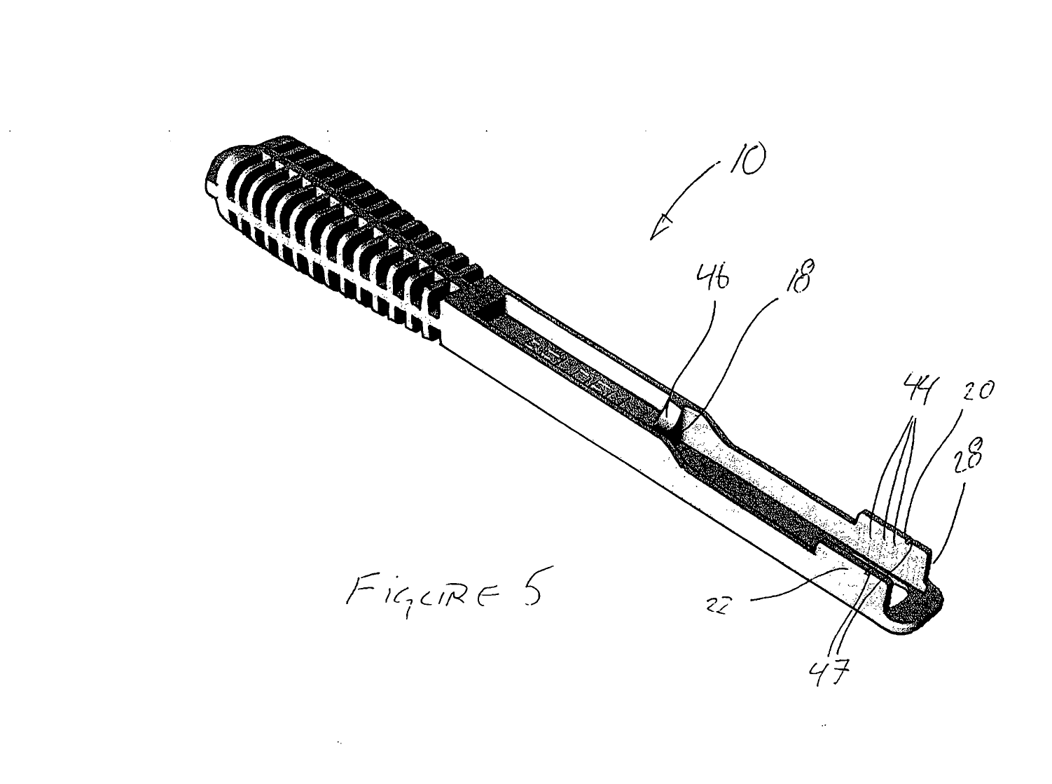

Referring now to FIG. 5, in alternative illustrative embodiment of the tool 10 the gripping surfaces as in 28 are corrugated with a series of ridges 44. Additionally, a notch 46 can be formed in the stabilising cross member(s) 18 in order to better accommodate the cable (reference 30 in FIG. 2) when the connector 32 is being retained between the opposed gripping members 20, 22. Furthermore, a notch, slot or other indicator 47 (such as a coloured line or the like) could be included on the outer edges of the gripping members 20 in order to aid the installer in positioning the connector between the gripping members 20.

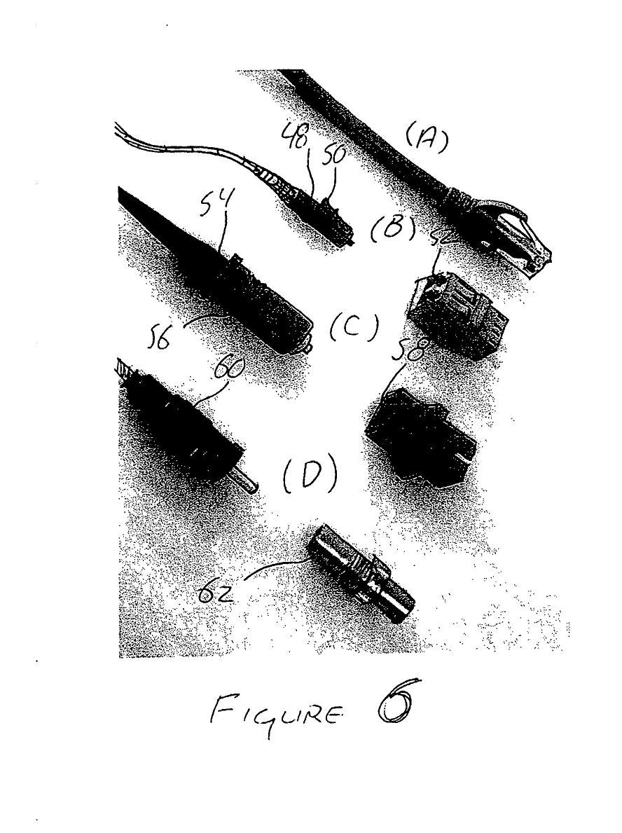

Referring to FIGS. 6A through 6D, although the present invention has been illustrated using an RJ-45 style connector (FIG. 6A) and socket, the tool with suitable modifications may also be used in aiding the installation and extraction of plugs or connectors of a variety of technologies including LC, SC and ST coaxial connectors. For example, LC style connectors (reference 48 in FIG. 6B) use a similar latch assembly 50 to retain the connector 48 within the socket 52, but are considerably smaller than the RJ-45 style connectors. SC style connectors (reference 54 in FIG. 6C) on the other hand do not use a latch but rather an outer sheath 56 must be retracted relative to the connector 54 in order to release the connector 54 from the socket 58. Additionally, ST coaxial style connectors (reference 60 in FIG. 6D) must typically be pushed inwards and rotated in order to release the connector 60 from its corresponding socket 62.

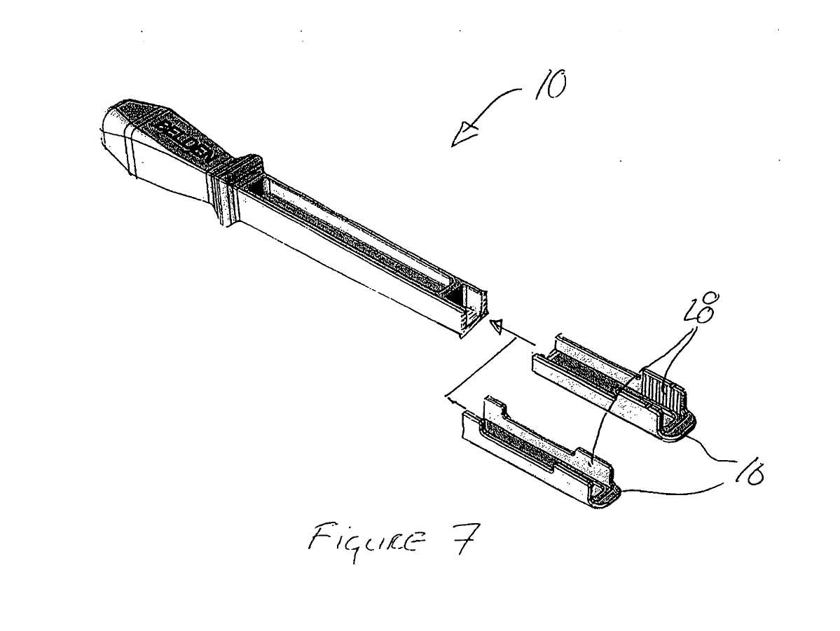

Referring to FIG. 7, in a second alternative illustrative embodiment of the present invention, and in order to simplify the use of the tool 10 with a variety of different styles of connectors, such as RJ-45, RJ-11, LC, SC, ST Co-axial, etc., the tool 10 can be supplied with a variety of interchangeable gripping tips as in 16, each of the gripping tips 16 configured to be used with a different style of connector. Additionally, and as discussed briefly above, the gripping tips 16 can be provided with a micro-adjust mechanism (not shown), for example using a screw or Allen key or the like, in order to provide for small adjustments to the pressure exerted by the inner gripping surfaces as in 28 on the respective connectors.

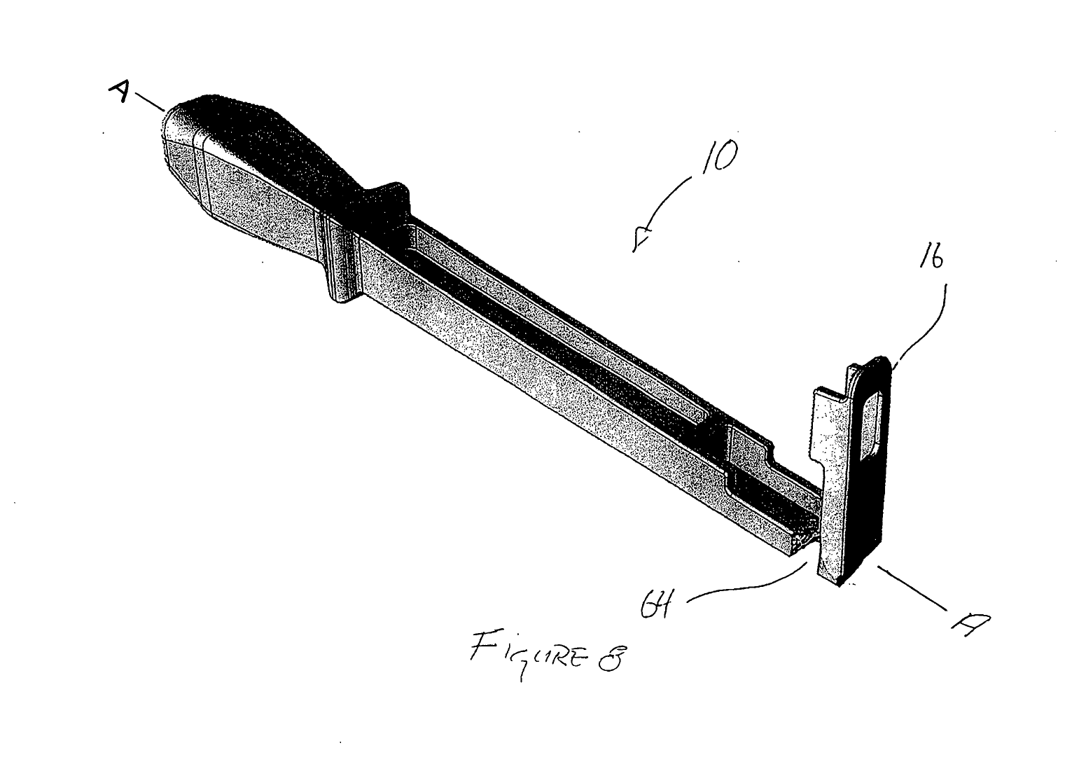

Referring to FIG. 8, in a third illustrative embodiment the connector gripping tip 16 can be arranged at an angle, illustratively perpendicular, to the general axis A of the tool 10, for example in order to allow access to difficult to reach areas such as behind desks and the like. In this regard, the tool 10 can also include a notch 64 or the like in order to provide for better passage of the cable (not shown) being disconnected using the tool 10.

Referring back to FIG. 1, a variety of other features can be combined with the tool 10 in order to improve its versatility or use in a given application. For example wiring cupboards are often poorly lit and therefore the incorporation of light emitting diode (LED) 66 or the like, a switch 68 for activating the LED 66 and a power supply such as a battery or the like is foreseen. Additionally, patch panels are often equipped with RFID tags which are used to identify the individual sockets and therefore incorporating an antenna in the tip 16, display on the handle 12 or shaft 14 and suitable electronics (all not shown) for identifying a particular socket in proximity to the tip 16 is also foreseen. Furthermore, the edge of the shaft 14 makes a good straight rule and the incorporation of a ruler along the shaft is also foreseen.

Referring to again to FIG. 4, the tip 16 of the installation tool 10 can further comprise a cable locating tool, illustratively in the form of a pair of tines as in 70 positioned on the shaft 14 behind the latch depressing portion 24 and which define a notch 72 there between. In use, the cable (not shown) is held in the notch 72 between the tines 70 and then the cable followed using the tines as in 70, separating the cable held between the tines as in 70 much in the manner of a comb. In an alternative embodiment the cable locating tool can be comprised of a notch 74 or the like fashioned in the shaft 14.

Although the present invention has been described hereinabove by way of an illustrative embodiment thereof, this embodiment can be modified at will without departing from the spirit and nature of the subject invention.

What is claimed is:

1. An installation tool for manipulating a connector comprising a latch, tool comprising:
a shaft;
a handle attached to an end of said shaft; and
an installation tip attached to an opposite end of said shaft and fashioned from a single piece of material, said tip comprising a pair of opposed resilient gripping members defining a connector receiving region there between and a latch depressing portion positioned at an extreme end of said tip, said connector receiving region dimensioned to snugly receive the connector there between;
wherein when the connector is inserted between said gripping members, said gripping members grip the connector while said latch depressing portion simultaneously depresses the latch.

2. An installation tip for attachment an end of a shaft of an installation tool for manipulating a connector comprising a latch, the tool further comprising a handle attached to an opposite end of the shaft, the tip comprising:
a pair of opposed resilient gripping members defining a connector receiving region there between; and
a latch depressing portion positioned at an extreme end of said tip, said connector receiving region dimensioned to snugly receive the connector there between;
wherein said tool is fashioned from a single piece of material.
